(19) United States
(12) Patent Application Publication
(10) Pub. No.: US 2026/0162960 A1
(43) Pub. Date: Jun. 11, 2026

(54) CONTROLLED PRE-LITHIATION OF A NEGATIVE ELECTRODE, PRE-LITHIATED NEGATIVE ELECTRODE, AND ALL-SOLID-STATE BATTERY

(71) Applicants: LG ENERGY SOLUTION, LTD., Seoul (KR); THE REGENTS OF THE UNIVERSITY OF CALIFORNIA, Oakland, CA (US)

(72) Inventors: Jeongbeom LEE, San Diego, CA (US); Min Sang SONG, Daejeon (KR); Ying Shirley MENG, San Diego, CA (US); So-Yeon HAM, San Diego, CA (US)

(73) Assignees: LG ENERGY SOLUTION, LTD., Seoul (KR); THE REGENTS OF THE UNIVERSITY OF CALIFORNIA, Oakland, CA (US)

(21) Appl. No.: 18/969,989

(22) Filed: Dec. 5, 2024

(51) Int. Cl. H01M 4/04; H01M 4/02; H01M 4/38; H01M 4/48; H01M 10/052

(52) U.S. Cl. CPC H01M 4/0445; H01M 4/043; H01M 4/386; H01M 4/483; H01M 10/052; H01M 2004/021; H01M 2004/027; H01M 2220/20

(57) ABSTRACT

Disclosed is a method for pre-lithiating a negative electrode for an all-solid-state battery and a negative electrode precursor. The method includes contacting a surface of the negative electrode with a solid electrolyte and applying a first pressure to form a first solid electrolyte layer on the negative electrode, applying additional solid electrolyte on a surface of the first solid electrolyte layer opposite a surface facing the negative electrode and applying a second pressure to form a second solid electrolyte layer on the surface of the first solid electrolyte layer, bringing a lithium metal into contact with a surface of the second solid electrolyte layer opposite a surface facing the first solid electrolyte layer, charging the negative electrode during at least one initial cycle for a duration of time to form a pre-lithiated negative electrode; and removing the lithium metal from the surface of the second solid electrolyte layer.

### FIELD OF TECHNOLOGY

The present disclosure relates to a method for pre-lithiation of a negative electrode, a negative electrode precursor, a pre-lithiated negative electrode, and a lithium all-solid-state battery including the pre-lithiated negative electrode.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

Conventional liquid lithium-ion batteries were critical to the advancement of electrified transportation and energy storage systems, and have had a significant and positive impact on green energy and climate change mitigation efforts. While such conventional liquid lithium-ion batteries are superior to many other energy sources, liquid lithium-ion batteries also have certain limitations. For example, various safety mechanisms are critical for lithium-ion batteries to restrict voltage and internal pressures, but these safety features typically result in increased weight and performance limitations in certain instances. Moreover, lithium-ion batteries are susceptible to aging, leading to capacity loss and eventually failure after a number of years of use.

In an all-solid-state battery, a solid electrolyte is used instead of a liquid electrolyte, making the entire battery solid. In a conventional solid state battery, a solid electrolyte replaces a liquid electrolyte system, and thus reduces the risk of ignition or explosion, thereby increasing safety. The solid electrolyte is intrinsically non-flammable and may accommodate a wider temperature range, allowing it to function as electrochemical energy storage without the need for additional safety devices. Solid state batteries, which offer higher energy density and are safer than batteries with a liquid electrolyte system, such as conventional lithium-ion batteries.

Generally, a carbon material such as graphite is used as a negative electrode of an all-solid-state battery, but the theoretical capacity density of carbon is 372 mAh/g (833 mAh/cm³). Therefore, silicon (Si), tin (Sn), oxides thereof, and alloys thereof, which are alloyed with lithium to improve the energy density of the negative electrode, are examined as negative electrode materials. Among them, silicon-based materials have received attention due to their low cost and high capacity (4200 mAh/g).

However, silicon has poor mechanical stability due to volume change during intercalation/deintercalation of lithium ions and there is a problem that cycle characteristic is deterred. Therefore, it is necessary to develop a material with excellent stability and capable of ensuring cycle characteristics when the material used as an active material of an electrochemical device by having structural stability. In addition, when the silicon-containing negative electrode active material is used, there is a problem that an initial irreversible capacity is large. In charging/discharging reaction of the lithium secondary battery, a lithium released from a positive electrode is intercalated in negative electrode during charging, and the lithium returns to the positive electrode during discharging. In the case of the silicon anode active material, the volume change and the surface side reaction are so severe that a large amount of lithium intercalated into the negative electrode at the time of initial charging cannot return to the positive electrode again, resulting in an increase in initial irreversible capacity. When the initial irreversible capacity increases, there occurs a problem that the battery capacity and the cycle are rapidly reduced.

In order to solve the above problems, methods of pre-lithiating a silicon oxide negative electrode including a silicon-containing negative electrode active material have been proposed. For example, U.S. Pat. No. 11,575,117, which is hereby incorporated by reference, discloses a method for pre-lithiating a silicon oxide negative electrode for a secondary battery by immersing the silicon oxide negative electrode in an electrolytic solution for wetting, and by applying pressure while a lithium metal is in direct contact with the wetted silicon oxide negative electrode.

However, there is still a need to secure technology to increase the energy density of safer all-solid-state batteries. Moreover, in the case of silicon oxide anodes for all-solid-state batteries, there are limitations on the energy density and lifespan performance due to large irreversible reactions and low efficiency. Thus, there exists a need for improved methods for pre-lithiating silicon oxide anode materials to be used in all-solid-state lithium battery structures, which are suitable for use in the industry and that are safe and cost-effective. Therefore, continuous efforts are conducted to develop a lithium secondary battery having improved safety and lifetime characteristics while having a high capacity and lifespan compared to conventional lithium-ion batteries.

### SUMMARY

Disclosed aspects solve these and other problems associated with conventional all-solid-state batteries by controlled pre-lithiation of a silicon-containing metal anode layer, on the negative electrode current collector. The inventors found that by controlling parameters of the pre-lithiation, e.g., solid electrolyte compression pressure and time, and the use of a sacrificial solid electrolyte layer has been shown to exhibit a battery with high first cycle coulombic efficiency and excellent life performance.

In one aspect, there is provided a method of pre-lithiating a negative electrode for an all-solid-state battery comprising a contacting a surface of the negative electrode with a solid electrolyte and applying a first pressure to form a first solid electrolyte layer on the negative electrode, applying additional solid electrolyte on a surface of the first solid electrolyte layer opposite a surface facing the negative electrode and applying a second pressure to form a second solid electrolyte layer on the surface of the first solid electrolyte layer, bringing a lithium metal into contact with a surface of the second solid electrolyte layer opposite a surface facing the first solid electrolyte layer, charging the negative electrode during at least one initial cycle for a duration of time to form a pre-lithiated negative electrode, and removing the lithium metal from the surface of the second solid electrolyte layer.

The second solid electrolyte layer may be removed when the lithium metal is removed.

The at least one initial cycle may be a first cycle.

The second pressure may be less than the first pressure.

The first pressure may be in a range of 100 MPa to 1,000 MPa.

The first pressure may be in a range of 200 MPa to 500 MPa.

The second pressure may be in a range of 10 MPa to 200 MPa.

The second pressure may be in a range of 50 MPa to 150 MPa.

The first pressure may be applied for a first duration of time and the second pressure may be applied for a second duration of time, and the second duration of time may be less than the first duration of time.

The first pressure may be applied for a first duration of time in a range of 30 seconds to 2 hours.

The second pressure may be applied for a second duration of time in a range of 1 second to 10 minutes.

The first pressure may be in a range of 100 MPa to 1,000 MPa and may be applied for a first duration of time in a range of 30 seconds to 2 hours, and the second pressure may be in a range of 10 MPa to 200 MPa and may be applied for a second duration of time in a range of 1 second to 10 minutes.

The negative electrode may comprise a negative electrode active material layer comprising at least one of a silicon-containing material and a tin-containing material.

The negative electrode may comprise SiOx, wherein 0≤x<2.

A thickness of the first solid electrolyte layer may be in a range of 100 μm to 1 mm.

A thickness of the second solid electrolyte layer may be in a range of 0.5 μm to 10 μm.

An area density of lithium in the second solid electrolyte layer may be in a range of 1 mg/cm² to 50 mg/cm².

In another aspect, there is provided a negative electrode precursor for an all-solid-state battery. The negative electrode precursor comprises a negative electrode, a first solid electrolyte layer on a surface of the negative electrode, and a second solid electrolyte layer on a surface of the first solid electrolyte layer opposite a surface facing the negative electrode. The second solid electrolyte layer is configured to be removed from the surface of the first solid electrolyte layer after an initial charging of the negative electrode during at least one initial cycle for a duration of time.

A lithium metal may be on a surface of the second solid electrolyte layer opposite a surface facing the first solid electrolyte layer. The lithium metal may be configured to be removed with the second solid electrolyte layer after the initial charging of the negative electrode.

In another aspect, there is provided a lithium all-solid-state battery comprising a positive electrode and a pre-lithiated negative electrode on the positive electrode.

In another aspect, there is provided an electric vehicle comprising the lithium all-solid-state battery.

Each aspect may further have one or more additional elements in any combination.

### BRIEF DESCRIPTION OF THE DRAWINGS

The accompanying drawings illustrate aspects of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIGS. 1A, 1B, 1C, 1D, and 1E show a method of pre-lithiating a negative electrode according to an aspect.

FIG. 2 shows charge capacities of negative electrodes pre-lithiated according to conventional methods.

FIG. 3 shows charge capacity of a negative electrode pre-lithiated according to disclosed aspects.

FIG. 4 shows discharge capacity retention and columbic efficiency of the pre-lithiated negative electrode in FIG. 3 by cycle.

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed. Unless defined otherwise, all the technical and scientific terms used herein have the same meanings as commonly known by a person skilled in the art. In the case that there is a plurality of definitions for the terms herein, the definitions provided herein will prevail.

Unless specified otherwise, all the percentages, portions and ratios in the present disclosure are on weight basis.

Unless indicated to the contrary, the numerical parameters set forth in the following specification and attached claims are approximations that may vary depending upon the desired properties sought to be obtained according to aspects of the disclosure. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

While compositions and methods are described herein in terms of “comprising” various components or steps, the compositions and methods may also “consist essentially of” or “consist of” the various components and steps. The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure. The terms “about” and “approximate”, when used along with a numerical variable, generally means the value of the variable and all the values of the variable within an experimental error (e.g., 95% confidence interval for the mean) or within a specified value 10% or within a broader range. Unless otherwise indicated, all numbers expressing quantities of ingredients, properties such as molecular weight, reaction conditions, and so forth used in the present specification and associated claims are to be understood may be modified by the term “about.”

“A and/or B” when used in this specification, specifies “either A or B or both.”

As used herein, the term “average particle size” means average obtained particle size as observed using scanning electron microscopy (SEM).

As used herein, the term “mean particle size” means mean particle size as observed using SEM.

### <Method of Producing Negative Electrode>

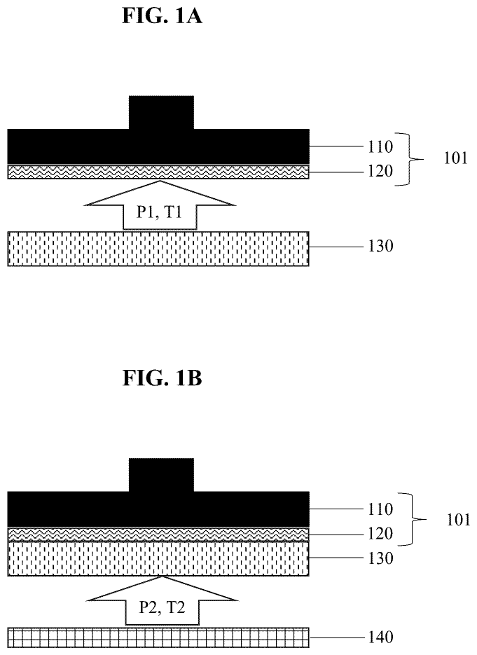

A method of producing a negative electrode for a lithium all-solid-state battery according to aspects is described below with reference to FIGS. 1A-1E.

The method includes a step of contacting a surface of a negative electrode 101 with a solid electrolyte 130, as shown in FIG. 1A. In FIG. 1A, the negative electrode 101 is shown including a negative electrode current collector 110 and negative electrode active material 120. It is understood that the negative electrode 101 may be an anode-free negative electrode and may only include the negative electrode current collector 110.

The method includes applying a first pressure P1 to the solid electrolyte 130 on the surface of the negative electrode 101 for a first duration of time T1 to form a first solid electrolyte layer 130 on the negative electrode 101, as shown in FIG. 1A. The first solid electrolyte layer 130 may be formed or disposed directly or indirectly on the negative electrode 101.

The first pressure P1 may be in a range of 50 MPa to 2,000 MPa, 75 MPa to 1,500 MPa, 100 MPa to 1,000 MPa, 50 MPa to 500 MPa, 200 MPa to 500 MPa, or 350 MPa to 450 MPa. The first duration of time T1 may be in a range of 1 second to 10 hours, 10 seconds to 10 hours, 30 seconds to 4 hours, 30 seconds to 2 hours, 5 minutes to 1 hour, or 10 minutes to 30 minutes. In some aspects, the first pressure P1 may be 380 MPa and the first duration of time T1 may be 3 minutes, the first pressure P1 may be 50 Mpa and the first duration of time T1 may be 10 hours, or the first pressure P1 may be 500 Mpa and the first duration of time T1 may be 1 second.

The method includes a step of contacting a surface of the first solid electrolyte layer 130 opposite a surface facing the negative electrode 101 with a solid electrolyte 140, as shown in FIG. 1B.

The method includes applying a second pressure P2 to the solid electrolyte 140 on the surface of the first solid electrolyte layer 130 for a second duration of time T2 to form a second solid electrolyte layer 140 on the first solid electrolyte layer 130, as shown in FIG. 1B. The second solid electrolyte layer 140 may be formed or disposed directly or indirectly on the first solid electrolyte layer 130.

The second pressure P2 may be in a range of 1 MPa to 500 MPa, 10 MPa to 300 MPa, 25 MPa to 200 MPa, 50 MPa to 150 MPa, or 75 MPa to 125 MPa. The second duration of time T2 may be in a range of 1 second to 1 hour, 5 seconds to 30 minutes, 10 seconds to 10 minutes, 10 seconds to 1 minute, or 15 seconds to 45 seconds.

In aspects, the pressure and duration parameters may be controlled or optimized. For example, the second pressure P2 may be less than or equal to the first pressure P1 and/or the second time T2 may be less than or equal to the first time T1. In preferred aspects, the second pressure P2 is less than the first pressure P1 and the second time T2 is less than the first time T1.

The method includes bringing a lithium metal 150 into contact with a surface of the second solid electrolyte layer 140 opposite a surface facing the first solid electrolyte layer 130, as shown in FIG. 1C. The lithium metal 150 may be formed or disposed directly or indirectly on the second solid electrolyte layer 140.

The negative electrode 101 is charged during an initial cycle for a duration of time to form a lithiated (i.e., pre-lithiated) negative electrode 201. The pre-lithiation according to disclosed aspects is not particularly limited and may be conducted according to any suitable method known in the art. For example, the initial cycle is the first and/or only initial cycle.

During initial charge or pre-lithiation of the negative electrode 101, lithium metal is reversibly deposited on the negative electrode 101 by movement of lithium ions from the lithium metal 150 to the negative electrode 101 through charge, as illustrated in FIG. 1C. In this manner, the negative electrode 101 is pre-lithiated to form the pre-lithiated negative electrode 201.

The parameters of the initial charge for pre-lithiating the negative electrode 101 are not particularly limited. In this pre-lithiation, the negative electrode 101 may not be fully lithiated. The negative electrode 101 should be pre-lithiated to compensate the initial capacity loss, so the pre-lithiation may be partial lithiation of negative electrode. In the pre-lithiation process, Li—Si is formed on or in the negative electrode active material layer 120.

The method further includes, after pre-lithiation and before subsequent charging, removing the lithium metal 150 from the surface of the second solid electrolyte layer 140, as shown in FIG. 1D. The method may further include removing the second solid electrolyte layer 140 during or after removal of the lithium metal 150, as also shown in FIG. 1D.

As seen in FIG. 1E, an all-solid-state battery 300 may be formed by contacting the pre-lithiated negative electrode 201 with a positive electrode 301. The positive electrode 301 may be formed or disposed directly or indirectly on the pre-lithiated negative electrode 201. The positive electrode 301 may include a positive electrode current collector 310 and a positive electrode active material 320.

During discharge of the all-solid-state battery 300, the pre-lithiated lithium ions are “stripped” and transferred back to the positive electrode active material layer 320, while the pre-lithiated negative electrode active material layer 120 remains as the negative electrode active material layer, and the thus formed negative electrode, for subsequent charge/discharge cycles.

### <All-Solid-State Battery>

An aspect of the present disclosure relates to the all-solid-state battery 300 comprising the pre-lithiated negative electrode 201 formed according to the method of producing a negative electrode described above. Specific examples of the all-solid-state battery include any type of primary battery, secondary battery, fuel cell, solar cell or capacitor such as a super capacitor. In aspects, the battery may be a lithium-ion secondary battery. Aspects of the disclosure herein may be implemented in a secondary battery with various form factors or battery formats, including for example in a pouch-type battery, a cylindrical battery, or a prismatic battery.

According to aspects, the all-solid-state battery 300 may be a lithium all-solid-state battery comprising the positive electrode 301, the negative electrode 101, and the solid electrolyte layer 130 between the negative electrode 101 and the positive electrode 301. The lithium all-solid-state battery 301 may comprise the negative electrode active material layer 120 on the surface of the negative electrode current collector 110 facing the first solid electrolyte layer 130. The battery 300 may further comprise a separator (not shown) between the negative electrode 101 and the positive electrode 301. The separator may be a separate layer or the solid electrolyte layer 130 may function as both a separator and electrolyte.

The all-solid-state battery 300 according to aspects may endure charging and discharging cycles up to a current density as high as 1.0 mA/cm², 2.0 mA/cm², 2.5 mA/cm², 3.0 mA/cm², 4.0 mA/cm², 5.0 mA/cm², or even 10.0 mA/cm².

### <Negative Electrode Active Material Layer>

According to aspects, the negative electrode active material layer 120 may comprise any suitable metal-containing material. For example, the metal-containing material may include, but is not limited to, Si, Al, Sn, Zn, Sb, Mg, C, and/or VGCF in pure form or in alloys or oxides. Preferably, the metal layer is a silicon-containing metal layer comprising SiOₓ, wherein 0≤x<2. Silicon oxide lowers the theoretical capacity of the battery but acts as a buffer and exhibits lower volume change after charging and a higher Li ion diffusion coefficient compared to, for example, pure silicon.

For purposes of this disclosure, the negative electrode active material layer 120 may be referred to as a silicon-containing metal layer. In aspects, the characteristics of the silicon-containing metal layer are important in improving the critical current density and overall performance of the all-solid-state battery 300. The characteristics include, but are not limited to, N/P ratio of a charge capacity of the silicon-containing metal layer (N) to a charge capacity of the positive electrode (P), thickness of the layer, and morphology.

In some aspects, the silicon-containing metal layer may have a thickness in a range of 1 nm to 10 μm, 5 nm to 5 μm, 10 nm to 5 μm, 20 nm to 3 μm, 40 nm to 2 μm, 50 nm to 1 μm, 60 nm to 800 nm, 70 nm to 700 nm, 80 nm to 600 nm, 100 nm to 500 nm, or 100 nm to 200 nm. In preferred aspects, the thickness is 50 nm to 200 nm. Controlling the thickness of the silicon-containing metal layer to be within the above ranges allows for suitable partial pre-lithiation of the silicon-containing metal layer and subsequent improved cycling characteristics.

### <Solid Electrolyte>

Any suitable sulfide-containing electrolyte material may be used for the solid electrolyte 130 and the solid electrolyte 140. In aspects, the solid electrolyte 130 may comprise a material that is the same or different from a material comprised in the solid electrolyte 140. In preferred aspects, the solid electrolyte 140 is a sacrificial layer that is used during the pre-lithiation process and then subsequently stripped before assembly of the all-solid-state battery 300.

A thickness of the first solid electrolyte layer 130 may be in a range of 1 μm to 5 mm, 10 μm to 2 mm, 100 μm to 1 mm, 200 μm to 700 μm, or 400 μm to 600 μm. An area density of lithium in the first solid electrolyte layer is in a range of 0.01 mg/cm² to 200 mg/cm², 0.1 mg/cm² to 100 mg/cm², 1 mg/cm² to 50 mg/cm², 5 mg/cm² to 30 mg/cm², or 10 mg/cm² to 20 mg/cm².

A thickness of the second solid electrolyte layer 140 may be in a range of 0.01 μm to 100 μm, 0.1 μm to 50 μm, 0.5 μm to 10 μm, 1 μm to 5 μm, or 2 μm to 4 μm. An area density of lithium in the second solid electrolyte layer is in a range of 0.01 mg/cm² to 200 mg/cm², 0.1 mg/cm² to 100 mg/cm², 1 mg/cm² to 50 mg/cm², 5 mg/cm² to 30 mg/cm², or 10 mg/cm² to 20 mg/cm².

As used herein, “sulfide-based electrolyte” refers to an electrolyte that includes inorganic materials containing S which conduct ions (e.g., Li⁺), and which are suitable for electrically insulating the positive and negative electrodes of an electrochemical cell. Exemplary sulfide-containing electrolytes are set forth in Shaojie Chen et al., “Sulfide solid electrolytes for all-solid-state lithium batteries: Structure, conductivity, stability and application,” Energy Storage Materials, Volume 14, Pages 58-74 (September 2018), which is hereby expressly incorporated by reference in its entirety.

For example, many sulfide-containing electrolyte materials are particularly attractive due to their superionic conductivities (as high as ˜10⁻² S cm⁻¹) and deformability. In particular, Li₃P₇S₁₁, Li₁₀GeP₂Si₂, and Na₃PS₄ and Li₆PS₅Cl have been reported to exhibit high ionic conductivities; some even close to those of liquid electrolytes. According to aspects of the disclosure, the sulfide solid electrolyte materials also provide a low Young's modulus, which is beneficial for producing favorable interface contacts with electrode materials by simple cold pressing at room temperature.

The sulfide-containing solid electrolyte, according to aspects of the disclosure, may contain sulfur (S) and have the ionic conductivity of metal belonging to Group I or II in the periodic table, e.g., Li⁺. Additionally, in an aspect of the present disclosure, the selected solid electrolyte has the ionic conductivity of 1×10⁻⁵ S/cm, or according to some aspects of the disclosure, 1×10⁻³ S/cm or more.

Non-limiting examples of the sulfide-containing solid electrolyte may include Li—P—S-based glass, Li—P—S-based glass ceramic and argyrodite-based sulfide-containing solid electrolyte.

Non-limiting examples of the sulfide-containing solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li₆PS₅X (X=at least one of Cl, Br or I).

In an aspect of the present disclosure, the sulfide-containing solid electrolyte may comprise at least one selected from LPS-based glass or glass ceramic such as xLi₂S-yP₂S₅, or an argyrodite-based sulfide-containing solid electrolyte (Li₆PS₅X; X═Cl, Br, I).

In another aspect, the solid electrolyte may include a solid electrolyte commonly used in the all-solid-state battery, such as an inorganic solid electrolyte or an organic solid electrolyte may be used.

In the case of the inorganic solid electrolyte, a ceramic material, a crystalline material or an amorphous material may be used. For instance, inorganic solid electrolytes such as thio-LISICON (Li_{3.25}Ge_{0.25}P_{0.75}S₄), Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄, Li₇P₃S₁₁, Li₂O—B₂O₃, Li₂O—B₂O₃—P₂O₅, Li₂O—V₂O₅—SiO₂, Li₂O—B₂O₃, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}Nw (wherein w is w<1), and Li_{3.6}Si_{0.6}P_{0.4}O₄ may be used.

The average size of sulfide-based particles is, for example, 0.1 μm to 50 μm, or 0.5 μm to 20 μm, which is within the size range of sulfide-based particles used in well-known all-solid-state batteries. In the case in which the average size of the sulfide-based particles is less than the above range, the sulfide-based particles may form lumps. In the case in which the average size of the sulfide-based particles is greater than the above range, on the other hand, the porosity of the manufactured solid electrolyte is high, whereby the characteristics of the battery may be deteriorated. For example, the capacity of the battery may be reduced.

The sulfide-based particle may have an ion conductivity of 1×10⁻⁴ S/cm or more, or the sulfide-based particle may have an ion conductivity of 1×10⁻³ S/cm or more.

In addition to the above-mentioned sulfide-based solid electrolytes, other well-known solid electrolytes may also be used. For example, an inorganic solid electrolyte, such as Li₂O B₂O₃, Li₂O—B₂O₃—P₂O₅, Li₂O—V₂O₅SiO₂, Li₃PO₄, Li₂O—Li₂WO₄—B₂O₃, LiPON, LiBON, Li₂O—SiO₂, LiI, Li₃N, Li₅La₃Ta₂O₁₂, Li₇La₃Zr₂O₁₂, Li₆BaLa₂Ta₂O₁₂, Li₃PO_{(4-3/2w)}N_{w} (w<1), or Li_{3.6}Si_{0.6}P_{0.4}O₄, may be used.

In addition, examples of the organic solid electrolyte include organic solid electrolytes prepared by mixing lithium salt to polymeric materials such as polyethylene derivatives, polyethylene oxide derivatives, polypropylene oxide derivatives, phosphate ester polymers, agitation lysine, polyester sulfide, polyvinyl alcohol, and polyvinylidene fluoride. In this case, these may be used alone or in combination of at least one.

In preferred aspects, the solid electrolyte may be Li₇La₃Zr₂O₁₂ (LLZO) and Li₆PS₅Cl (LPSCl) and LiPON.

### <Negative Electrode Current Collector>

The negative electrode current collector 110 is not particularly limited as long as it is conductive without causing any chemical change in the all-solid-state battery 300, and for example, copper, stainless steel, aluminum, nickel, titanium, sintered carbon, copper or stainless steel whose surface is treated with carbon, nickel, titanium, silver or the like, or aluminum-cadmium alloy, etc., may be used. In preferred aspects, the negative electrode current collector 110 is copper. Additionally, the negative electrode current collector 110 may include various forms such as a film, a sheet, a foil, a net, a porous body, a foam, and a nonwoven fabric having minute irregularities formed on their surfaces.

### <Positive Electrode>

In the positive electrode 301, a positive electrode current collector 310 may be used, and is not particularly restricted, as long as the positive electrode current collector 310 exhibits high conductivity while the positive electrode current collector 310 does not induce any chemical change in the battery to which the positive electrode current collector is applied. For example, the positive electrode current collector 310 may be made of stainless steel, aluminum, nickel, titanium, or plastic carbon. Alternatively, the positive electrode current collector 310 may be made of aluminum or stainless steel, the surface of which is treated with carbon, nickel, titanium, or silver.

The positive electrode current collector 310 is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

A positive electrode active material 320 includes an excellent positive electrode active material particle for sulfide-based all-solid-state batteries, the surface of which is reformed, according to the present disclosure. In addition, an additional material may be used depending on what a lithium secondary battery is used for. For example, a transition-metal-compound-based active material or a sulfide-based active material may be used.

Some aspects relate to wherein the cathode positive electrode further comprises a positive electrode material, a solid electrolyte and a conductive agent. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co_{1-x-y}O₂. In some aspects, the positive electrode material comprises at least one of LiCoO₂, LiMn₂O₄, LiMnO₂, or LiNiO₂. In some aspects, the positive electrode material comprises sulfur.

In some aspects of the present disclosure, the positive electrode active material 320 may comprise at least one of lithium cobalt oxide (LiCoO₂), lithium nickel oxide (LiNiO₂), lithium manganese oxide of Formula Li₁₊ₓMn₂₋ₓO₄ (x is 0 to 0.33, for example LiMn₂O₄), LiMnO₃, LiMn₂O₃, LiMnO₂, lithium copper oxide (Li₂CuO₂); vanadium oxide such as LiV₃O₈, LiV₂O₄, V₂O₅, Cu₂V₂O₇, Ni-site lithium nickel oxide represented by Formula LiNi₁₋ₓMₓO₂ (M=Co, Mn, Al, Cu, Fe, Mg, B or Ga, 0<x<1), for example, LiNi_{1-z}(Co,Mn,Al)_{z}O₂ (0<z<1); lithium manganese composite oxide represented by Formula LiMn₂₋ₓMₓO₄ (M=Co, Ni, Fe, Cr, Zn or Ta, x=0.01˜1, for example, LiMn_{1.5}Ni_{0.5}O₄ or Li₂Mn₃MO₈(M=Fe, Co, Ni, Cu or Zn); LiMn₂O₄ with partial substitution of alkali earth metal ion for Li in Formula; disulfide compounds; Fe₂(MoO₄)₃, or lithium iron phosphate (LiFePO₄). In some aspects of the present disclosure, the lithium iron phosphate may have all or at least part of the of the active material particle surface coated with a carbon material to improve conductivity.

According to aspects of the disclosure, the positive electrode active material 320 may comprise at least one selected from Lithium Nickel Cobalt Manganese Oxide (for example, Li(Ni,Co,Mn)O₂, LiNi_{1-z}(Co,Mn,Al)_{z}O₂ (0<z<1)), Lithium Iron Phosphate (for example, LiFePO4/C), Lithium Nickel Manganese Spinel (for example, LiNi_{0.5}Mn_{1.5}O₄), Lithium Nickel Cobalt Aluminum Oxide (for example, Li(Ni,Co,Al)O₂), Lithium Manganese Oxide (for example, LiMn₂O₄) and Lithium Cobalt Oxide (for example, LiCoO₂).

According to some aspects of the present disclosure, the positive electrode active material 320 may comprise lithium transition metal composite oxide, and the transition metal may comprise at least one of Co, Mn Ni or Al.

In some aspects of the present disclosure, the lithium transition metal composite oxide may comprise at least one of compounds represented by the following formula 1.

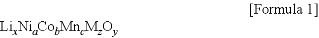

In the above Formula 1, 0.5≤x≤1.5, 0<a≤1, 0≤b<1, 0≤c<1, 0≤z<1, 1.5<y<5, a+b+c+z is 1 or less, and M may comprise at least one selected from Al, Cu, Fe, Mg and B.

In some aspects of the present disclosure, the positive electrode active material 320 includes a positive electrode active material having high Ni content of a of 0.5 or more, and its specific example may comprise LiNi_{0.8}Co_{0.1}Mn_{0.1}O₂.

In some aspects of the present disclosure, the positive electrode conductive material 320 may comprise, for example, at least one conductive material selected from the group consisting of graphite, carbon black, carbon fibers or metal fibers, metal powder, conductive whiskers, conductive metal oxide, activated carbon or polyphenylene derivatives. More specifically, the positive electrode conductive material may be at least one conductive material selected from the group consisting of natural graphite, artificial graphite, super-p, acetylene black, ketjen black, channel black, furnace black, lamp black, thermal black, denka black, aluminum powder, nickel powder, zinc oxide, potassium titanate and titanium oxide.

The current collector 310 is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The positive electrode binder resin may include polymer for electrode commonly used in the technical field. Non-limiting examples of the binder resin may include, but are not limited to, polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose.

In some aspects of the present disclosure, the solid electrolyte included in the positive electrode may comprise at least one selected from a polymer-based solid electrolyte, an oxide-based solid electrolyte and a sulfide-containing solid electrolyte. In some aspects of the present disclosure, the positive electrode active material may comprise the sulfide-containing solid electrolyte described in the solid electrolyte membrane.

In some aspects of the present disclosure, the positive electrode active material is included in the positive electrode in an amount of 50 wt % or more based on 100 wt % of the positive electrode active material layer. Additionally, the solid electrolyte is, according to aspects of the disclosure, included in the positive electrode in an amount of 10 wt % to 40 wt % based on 100 wt % of the positive electrode active material layer.

### <Method of Manufacturing Battery>

In aspects, the battery 300 is assembled by setting a thickness of the silicon-containing layer and a ratio of the silicon-containing layer load amount to the cathode load amount, i.e., N/P ratio, to be within specified ranges, and then charging by the cathode load amount, whereby intercalation of the silicon-containing layer and plating of lithium metal are continuously performed, thereby manufacturing a lithium secondary battery. In the lithium secondary battery thus manufactured, both the pre-lithiated silicon-containing layer previously included during the battery assembly and the plated lithium metal due to charging are used as the negative electrode active material. Therefore, the battery exhibits improved safety and lifetime characteristics while having a high capacity as compared with the conventional lithium-ion battery and lithium metal secondary battery.

Moreover, in the step of assembling the battery, since lithium metal is not separately handled, blocking of moisture and oxygen is unnecessary and thus, the assembly process is simple. And when lithium metal is plated, since the specific surface area of the negative electrode active material layer, which is the plating surface, is very large, the current density and overvoltage are significantly lower as compared with the lithium metal thin film. Therefore, the lithium metal does not grow in a dendritic shape and may be uniformly plated on the surface of the silicon-containing layer. Consequently, the plated lithium metal may be used as an active material.

The N/P of the battery and thicknesses and composition of the various layers may be as described herein with respect to other aspects.

Other methods are also contemplated by this disclosure. For example, the all-solid-state battery may be manufactured through a dry compression process, in which an electrode powder and solid electrolyte powder are manufactured, introduced into a predetermined mold, and pressed, or a slurry coating process, in which a slurry composition including an active material, a solvent, and a binder is manufactured, coated on a current collector, and dried.

In the present disclosure, the method of manufacturing the all-solid-state battery includes the methods of manufacturing the pre-lithiated negative electrode discussed herein. The contacting, placing, disposing, and/or facing steps discussed with respect to these methods may include any suitable methods known in the art. For example, the solid electrolyte may be disposed between the positive electrode and the negative electrode current collector, and then the same is compressed in order to assemble a cell. The assembled cell is mounted in a sheathing member, and then the sheathing member is encapsulated by heating and compression. A laminate case made of aluminum or stainless steel, a cylindrical metal container, or a prismatic metal container may be appropriately used as the sheathing member.

The respective electrode slurry may be coated on the corresponding current collector using a method of placing the electrode slurry on the current collector and uniformly dispersing the electrode slurry with a doctor blade, a die casting method, a comma coating method, or a screen-printing method. Alternatively, the electrode slurry and the current collector may be formed on a separate substrate, and the electrode slurry and the current collector may be joined to each other through pressing or lamination. At this time, the concentration of a slurry solution or the number of coatings may be adjusted in order to adjust the final coating thickness.

The drying process is a process of removing the solvent or moisture from the slurry in order to dry the slurry coated on the metal current collector. The drying process may vary depending on the solvent that is used. For example, the drying process may be performed in a vacuum oven having a temperature of 50° C. to 200° C. For example, drying may be performed using a warm-air drying method, a hot-air drying method, a low-humidity-air drying method, a vacuum drying method, a (far-) infrared drying method, or an electron beam radiation method. The drying time is not particularly restricted. In general, drying is performed within a range of 30 seconds to 24 hours.

After the drying process, a cooling process may be further performed. In the cooling process, slow cooling to room temperature may be performed such that the recrystallized structure of the binder is sufficiently formed.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

### <Lithium-Ion Batteries Generally>

### Lithium-Ion Batteries

A solid-state battery can receive a charge and discharge an electrical load at various times. A solid-state battery includes electrodes, a cathode electrode and an anode electrode, and an electrolyte to allow lithium ions to travel between the electrodes. In contrast to conventional liquid electrolyte batteries, the solid-state battery does not include any flowable liquids. Forming a circuit between the electrodes causes electricity to flow between the electrodes. During charging of the lithium-ion rechargeable battery, lithium ions are emitted from the cathode electrode and are intercalated into an active material of the anode electrode. During charging of the lithium-ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid-state battery comprising a cathode electrode, an anode electrode, and a solid electrolyte layer intermediate the cathode electrode and the anode electrode. In some aspects, the solid electrolyte may function as both an electrolyte and a separator. While listed as exemplary, the solid-state battery does not require all of these components. For example, in some configurations, such as in an anodeless system, the anode electrode may be omitted. Alternatively, according to aspects of the disclosure, the anode electrode may comprise an anode material with a metal carbon composite, such as a silver-carbon blend or composite, where silver particles are complexed between amorphous and/or crystalline carbon particles. While silver is used as exemplary, other metals may be used, including for example, tin, silicon, zinc, or combinations thereof.

The solid-state battery can optionally comprise an additional layer or layers, such as, for example, a separator layer, a protective layer, an inhibitor layer, a solid electrolyte interface layer, or a combination thereof. For example, a protective layer may be incorporated between the electrodes and the solid electrolyte layer. This protective layer may comprise materials such as lithium phosphate, lithium titanate, or lithium lanthanum zirconium oxide (LLZO), which can help prevent undesirable side reactions at the electrode-electrolyte interface. The protective layer may also serve to mitigate dendrite formation, particularly on the anode side, thereby improving the overall cycle life and safety of the battery. A separator layer may also be included in some configurations of the solid-state battery. While traditional liquid electrolyte batteries often use porous polymer separators, solid state batteries may employ thin ceramic or glass-ceramic layers as separators. These separator layers can provide additional mechanical support to the battery structure while still allowing for efficient ion transport. Materials such as LLZO, LATP (lithium aluminum titanium phosphate), or LAGP (lithium aluminum germanium phosphate) may be used for this purpose. The separator layer may also be designed to have a gradient structure, with properties optimized for contact with both the cathode and anode materials.

### Cell Configuration

The solid-state battery may comprise a single cell. In other aspects, the solid-state battery can comprise multiple cells, such as, at least two cells, at least three cells, or at least four cells. Connecting the cells in series increases a voltage of the solid-state battery and connecting the cells in parallel increases an amp-hour capacity of the solid-state battery. In some embodiments, the solid-state battery may be configured with a combination of series and parallel connections to achieve desired voltage and capacity characteristics. For example, multiple cells may be arranged in groups, with cells within each group connected in parallel to increase capacity, and these groups then connected in series to increase voltage. This configuration, sometimes referred to as a series-parallel arrangement, allows for greater flexibility in battery design and can help optimize performance for specific applications. Additionally, the number and arrangement of cells may be adjusted to meet various form factor requirements.

### Thickness of Cell

A thickness, t₁, of the cell can be about 100, 150, 200, 250, 300, 400, 500, 1,000 μm, 2,000 μm, or 5,000 μm. In embodiments, the thickness, t₁, of the cell may be within a range formed by selecting any two numbers listed in the immediately previous sentence, e.g., between about 100 μm and about 5,000 μm or about 100 μm and about 1,000 μm.

### Cathode Electrode Generally

The cathode electrode is associated with one polarity (e.g., positive) of the solid-state battery. The cathode electrode is configured as a positive electrode during discharge of the solid-state battery. The cathode electrode is suitable for lithium ion diffusion between a current collector and the solid electrolyte layer. The cathode electrode is in electrical communication with the current collector. In embodiments, the cathode electrode is formed over and in direct contact with the current collector. In other embodiments, another functional layer may be interposed between the cathode electrode and the current collector.

### Material for the Cathode Electrode

The cathode electrode may be capable of reversible intercalation and deintercalation of lithium ions. For example, the cathode electrode can comprise one or more of a cathode active material, a conductive carbon, a solid electrolyte material, a binder, the like, or combinations thereof. Optionally, the cathode electrode 102 may further comprise an additive, such as, for example, an oxidation stabilizing agent, a reduction stabilizing agent, a flame retardant, a heat stabilizer, an antifogging agent, a thickener, the like, or a combination thereof. Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners.

### Material for the Cathode Active Material

The cathode active material can include lithium cobalt oxide (LiCoO₂), lithium nickel oxide (LiNiO₂), Li[NiₐCo_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM²_{f-e-f}M³_{f′})O_{2-g}A_{g} (wherein 0≤e≤0.2, 0.6≤f≤1, 0≤f′≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄(wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

In addition to the cathode active materials previously mentioned, the cathode electrode may include other types of materials. For example, lithium iron phosphate (LiFePO₄) may be used as a cathode active material due to its excellent thermal stability and long cycle life. Other phosphate-based materials such as lithium manganese iron phosphate (LiMnₓFe₁₋ₓPO₄) or lithium cobalt phosphate (LiCoPO₄) may also be suitable.

The cathode active material may also include layered oxide materials with various compositions, such as Li(Ni_{1-x-y}CoₓMn_{y})O₂ (NCM) or Li(Ni_{1-x-y}CoₓAl_{y})O₂ (NCA), where the ratios of Ni, Co, Mn, and Al can be adjusted to optimize performance characteristics. For instance, NCM materials with high nickel content, such as NCM811 (LiNi_{0.8}Co_{0.1}Mn_{0.1}O₂), may be used to achieve higher energy density. In some cases, the cathode active material may comprise spinel structures like LiNi_{0.5}Mn_{1.5}O₄, which can offer high voltage operation. Alternatively, materials with favorite structures, such as LiFeSO₄F or LiVPO₄F, may be employed for their potential for high energy density and good thermal stability.

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

The cathode active material may also include emerging classes of materials such as disordered rock salt structures (e.g., Li₃NbO₄-based materials) or high-entropy oxides, which may offer unique combinations of high capacity and structural stability. In some cases, the cathode active material may incorporate dopants or substitutional elements to further tune its electrochemical properties.

### Particulate Nature of the Cathode Active Material

The cathode active material can be particle shaped. The cathode active material can comprise a particle size of about 10 nm, 20 nm, 30 nm, 50 nm, 70 nm, 100 nm, 200 nm, 300 nm, 400 nm, 500 nm, 1,000 nm, 10 μm, 20 μm, 30 μm, 50 μm, 70 μm, 100 μm, 200 μm, 300 μm, 400 μm, 500 μm, or 1,000 μm. In embodiments, particle size of the cathode active material may be within a range formed by selecting any two numbers listed in the immediately previous sentence, e.g., between about 10 nm and about 1,000 μm. Gaps between cathode active material in the cathode electrode can be filled with the solid electrolyte material.

### Amount of the Cathode Active Material in the Cathode Electrode

The amount of the cathode active material in the solid-state battery affects the charge and discharge capacity of the solid-state battery. In order to manufacture a high-capacity cathode electrode, a high level of cathode active material can be included in the cathode electrode. For example, the cathode electrode includes at, about, or greater than 30, 40, 50, 60, 70, 80, 90, 95, or 98 wt % of cathode active material based on the total weight of the cathode electrode. In embodiments, cathode active material in the cathode electrode may be within a range formed by selecting any two numbers listed in the immediately previous sentence, e.g., between about 40 wt % and about 98 wt %.

### Material for the Conductive Material in the Cathode Electrode

The conductive material in the cathode electrode is not particularly limited, as long as it has conductivity while not causing any chemical change in the corresponding solid-state battery. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive materials, such as polyphenylene derivatives; the like; or combinations thereof. Other conductive materials that may be used in the cathode electrode include graphene and its derivatives, such as reduced graphene oxide (rGO) or graphene nanoplatelets. These two-dimensional carbon materials offer high surface area and excellent electrical conductivity. Conductive polymers, such as polyaniline (PANI), polypyrrole (PPy), or poly(3,4-ethylenedioxythiophene) (PEDOT), may also be employed to enhance the electrode's conductivity while potentially improving its mechanical properties. In some cases, hybrid conductive additives combining different materials, such as CNT-graphene composites or metal-coated carbon materials, may be used to synergistically improve the overall conductivity and performance of the cathode electrode.

### Amount of Conductive Material in the Cathode Electrode

The cathode electrode includes at or about 1, 2, 5, 10, 15, 20, 25, or 30 wt % of conductive material based on the total weight of the cathode electrode. In embodiments, conductive material in the cathode electrode may be within a range formed by selecting any two numbers listed in the immediately previous sentence, e.g., between about 1 wt % and about 30 wt %.

### Material for the Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene):poly(styrene sulfonate) (PEDOT:PSS) or polyaniline (PANI) may be used to simultaneously improve both the mechanical integrity and electrical conductivity of the electrode. Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode includes at or about 1, 2, 5, 10, 15, 20, 25, or 30 wt % of binder based on the total weight of the cathode electrode. In embodiments, binder in the cathode electrode may be within a range formed by selecting any two numbers listed in the immediately previous sentence, e.g., between about 1 wt % and about 30 wt %.

### Material for Solid Electrolyte Material

The solid electrolyte material in the cathode electrode can be individually configured the same as the material for the solid electrolyte layer discussed below. The solid electrolyte material in the cathode electrode can be the same or different than the material for the solid electrolyte layer.

### Amount of Solid Electrolyte Material in Cathode Electrode

The cathode electrode 102 includes about 1, 2, 5, 10, 15, 20, 25, or 30 wt % of solid electrolyte material based on the total weight of the cathode electrode. In embodiments, the amount of solid electrolyte material in the cathode electrode may be within a range formed by selecting any two numbers listed in the immediately previous sentence, e.g., between about 1 wt % and about 30 wt %.

### Thickness of Cathode Electrode

A thickness, t₂, of the cathode electrode can be about 10, 20, 50, 100, 150, 200, 250, 300, 400, 500, or 1,000 μm. In embodiments, the thickness, t₂, of the cathode electrode may be within a range formed by selecting any two numbers listed in the immediately previous sentence, e.g., between about 10 μm and about 1,000 μm.

### Porosity of Cathode Electrode

A porosity of the cathode electrode can be about 0, 1, 2 3, 4, 5, 6, 7, 8, 9, 10, 11, 12, 13, 14, 15, 16, 17, or 18 vol % based on the total volume of the cathode electrode. In embodiments, the porosity of the cathode electrode may be within a range formed by selecting any two numbers listed in the immediately previous sentence, e.g., between 0 vol % and about 18 vol %.

### Lithium Ion Diffusivity of the Cathode Electrode

The cathode electrode can include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In embodiments, the lithium ion diffusivity of the cathode electrode may be within a range formed by selecting any two numbers listed in the immediately previous sentence, e.g., between 1×10⁻¹⁴ cm²/s and about 1×10⁻⁷ cm²/s.

### Current Collector at the Cathode Electrode

The current collector collects electrical energy generated at the cathode electrode and supports the cathode electrode. The material of the current collector is not particularly limited as long as it allows adhesion of the cathode electrode, has a suitable electrical conductivity, and does not cause significant chemical changes in the corresponding solid-state battery in the voltage range of the solid-state battery. For example, the current collector is made of or includes various materials, such as, a metal, a conductive carbon, or a conductive ceramic, although not limited thereto. The metal of the current collector may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Shape and Size of the Current Collector at the Cathode Electrode

It is possible to increase the adhesion of the cathode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. The current collector may also be configured in various other geometries to optimize its performance and integration with the cathode electrode, and may be sized for specific form factors, such as pouch, cylindrical, and/or prismatic form factors. For instance, the current collector may be structured as a mesh or grid, which can provide enhanced mechanical support while maintaining high surface area for electrode adhesion. In some embodiments, the current collector may be designed with a corrugated or wavy pattern, potentially increasing the contact area with the cathode material and improving overall conductivity. The current collector may also be fabricated as a perforated sheet, allowing for better electrolyte penetration and ion transport. In certain cases, the current collector may be formed as a three-dimensional structure, such as an interconnected network of fibers or a honeycomb-like configuration, which could enhance the structural integrity of the electrode assembly while facilitating efficient current collection.

### Thickness of Current Collector at the Cathode Electrode

A thickness, t₃, of the current collector can be about 3, 5, 10, 15, 20, 25, 50, 100, 150, 200, 300, 400, or 500 μm. In embodiments, the thickness, t₃, of the current collector 108 may be within a range formed by selecting any two numbers listed in the immediately previous sentence, e.g., between about 5 μm and about 500 μm.

### Manufacturing Method for the Cathode Electrode

The cathode electrode may be obtained by various methods. For example, the cathode active material can be mixed and agitated with a solvent, and optionally a binder, conductive material, and a dispersing agent to form slurry. Then, the slurry can be applied (e.g., coated) onto the current collector, followed by pressing and drying, to obtain the cathode electrode.

In addition to the slurry-based method described, the cathode electrode may be manufactured using various other techniques. For instance, a dry powder coating process may be employed, where the cathode active material, conductive additives, and binder are mixed in a dry state and then directly applied to the current collector using electrostatic deposition or mechanical compression. This method may reduce environmental impact by eliminating the need for solvents.

In some cases, the cathode electrode may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

Another method for manufacturing the cathode electrode may involve electrospinning. In this process, a solution containing the cathode active material, conductive additives, and a polymer binder is extruded through a nozzle under an electric field, resulting in the formation of nanofibers. These fibers can be collected directly on the current collector to form a highly porous electrode structure with increased surface area.

In some embodiments, the cathode electrode may be prepared using a tape casting method. This technique involves spreading a slurry of electrode materials onto a moving carrier film using a doctor blade, followed by drying and calendering. The resulting electrode tape can then be laminated onto the current collector.

Alternatively, the cathode electrode may be fabricated using a spray coating technique. In this method, a fine mist of the electrode slurry is sprayed onto the current collector using compressed air or ultrasonic atomization. This approach may allow for the creation of thin, uniform electrode layers and can be particularly useful for large-scale production.

In certain cases, the cathode electrode may be manufactured using a freeze-casting method. This process involves freezing a slurry of electrode materials, followed by sublimation of the ice to create a porous structure. The resulting porous electrode can then be sintered and attached to the current collector.

For some applications, the cathode electrode may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Application Methods for the Slurry for the Cathode Electrode

The application of the slurry to the cathode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In some embodiments, the cathode electrode may be fabricated using a double layer slot die coating (DLD) technique. This method involves the simultaneous application of two distinct layers of electrode materials onto the current collector in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for the Slurry for the Cathode Electrode

The solvent for forming the cathode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene. In some aspects of the disclosure, the cathode electrode may be prepared using a solvent-free method, such as dry powder processing or melt extrusion, which eliminates the need for liquid solvents and may offer environmental and cost benefits.

### Dispersing Agent for the Slurry for the Cathode Electrode

The dispersing agent forming the cathode electrode may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for the Cathode Electrode

The slurry for the cathode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode. In addition to the drying techniques mentioned, the cathode electrode may be dried using other methods such as infrared (IR) drying, microwave drying, or freeze-drying. In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode is associated with one polarity (e.g., negative) of the solid-state battery, which is different than the polarity of the cathode electrode. The anode electrode is configured as a negative electrode during discharge of the solid-state battery. The anode electrode is suitable for lithium ion diffusion between a current collector and the solid electrolyte layer. The anode electrode is in electrical communication with the current collector. In embodiments, the anode electrode is formed over and in direct contact with the current collector. In some embodiments, as explained above, the solid-state battery may utilize an anodeless electrode system. In such configurations, the anode electrode may be omitted, and lithium metal may be deposited directly onto the current collector during charging. This approach may potentially increase the energy density of the battery by eliminating the need for a separate anode material, while also potentially reducing the overall thickness of the battery structure.

### Material for the Anode Electrode

The anode electrode may be capable of reversible intercalation and deintercalation of lithium ions. For example, the anode electrode can comprise an anode active material, a binder, the like, or combinations thereof. Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof. Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Material for the Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOx (0<x<2), SnO₂, vanadium oxide or lithium vanadium oxide; and a composite including the metallic compound and the carbon-based material such as a Si—C composite or a Sn—C composite. A lithium metal thin film may be used as the anode active material. The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof. In addition to the materials mentioned, the anode active material may also include titanium-based compounds such as lithium titanate (Li₄Ti₅O₁₂) or titanium dioxide (TiO₂), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode is made of or includes lithium or a lithium alloy, dendrites may form on the anode electrode. The dendrites are a metallic lithium structure formed when extra lithium ions accumulate on a surface of the anode electrode. The formed dendrites may damage the solid electrolyte layer, reduce battery capacity of the solid-state battery, and/or otherwise lead to undesired performance of the solid-state battery. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, it is important to note that while solid electrolytes can significantly reduce the risk of dendrite growth, they may not completely eliminate it, and ongoing research aims to develop advanced solid electrolyte materials with enhanced dendrite suppression capabilities.

### Nature of the Anode Active Material

The anode active material can be particle shaped or it may be a continuous, unitary form (e.g., a thin film or sheet). In embodiments where the anode active material is particle shaped, the anode active material can comprise a particle size of about 10 nm, 20 nm, 30 nm, 50 nm, 70 nm, 100 nm, 200 nm, 300 nm, 400 nm, 500 nm, 1,000 nm, 10 μm, 20 μm, 30 μm, 50 μm, 70 μm, 100 μm, 200 μm, 300 μm, 400 μm, 500, or 1,000 μm. In embodiments, particle size of the anode active material may be within a range formed by selecting any two numbers listed in the immediately previous sentence, e.g., between about 10 nm and about 1,000 μm.

### Amount of Anode Active Material in the Anode Electrode

The amount of the anode active material in the solid-state battery affects the charge and discharge capacity of the solid-state battery. In order to manufacture a high-capacity anode electrode, a high level of anode active material can be included in the anode electrode. For example, the anode electrode includes at, about, or greater than 70, 80, 90, 95, 98, 99, or 100 wt % of anode active material based on the total weight of the anode electrode. In embodiments, anode active material in the anode electrode may be within a range formed by selecting any two numbers listed in the immediately previous sentence, e.g., between about 70 wt % and about 100 wt %.

### Material for Binder in the Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in the Anode Electrode

The anode electrode can include at or about 0, 1, 2, 5, 10, 15, 20, 25, or 30 wt % of binder based on the total weight of the anode electrode. In embodiments, binder in the anode electrode may be within a range formed by selecting any two numbers listed in the immediately previous sentence, e.g., between about 0 wt % and about 30 wt %.

### Thickness of the Anode Electrode

The anode electrode can be about 10, 20, 30 50, 60, 70, or 100 μm thick. In embodiments, the thickness, t₄, of the anode electrode 104 may be within a range formed by selecting any two numbers listed in the immediately previous sentence, e.g., between about 10 m and about 100 μm or about 10 μm and about 20 μm.

### Porosity of Anode Electrode

A porosity of the anode electrode can be about 0, 1, 2 3, 4, 5, 6, 7, 8, 9, 10, 11, 12, 13, 14, 15, 16, 17, or 18 vol % based on the total volume of the anode electrode. In embodiments, the porosity of the anode electrode may be within a range formed by selecting any two numbers listed in the immediately previous sentence, e.g., between 0 vol % and about 18 vol %.

### Lithium Ion Diffusivity of the Anode Electrode

The anode electrode can include a lithium ion diffusivity of about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In embodiments, the lithium ion diffusivity of the anode electrode may be within a range formed by selecting any two numbers listed in the immediately previous sentence, e.g., between 1×10⁻¹⁴ cm²/s and about 1×10⁻⁷ cm²/s.

### Current Collector at the Anode Electrode

The current collector collects electrical energy generated at the anode electrode 104 and supports the anode electrode. The material of the current collector is not particularly limited as long as it allows adhesion of the anode electrode, has a suitable electrical conductivity, and does not cause significant chemical changes in the corresponding solid-state battery in the voltage range of the solid-state battery. For example, the current collector is made of or includes a metal or a conductive carbon, although not limited thereto. The metal of the current collector may include one or more selected from the group consisting of aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape and Size of the Current Collector at the Anode Electrode

It is possible to increase the adhesion of the anode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. In addition to the shapes mentioned, the current collector may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector. Furthermore, the current collector may be designed to accommodate different form factors of solid-state batteries, such as pouch cells, cylindrical cells, or prismatic cells, each offering unique advantages in terms of packaging efficiency, thermal management, and overall battery performance.

### Thickness of Current Collector at the Anode Electrode

A thickness, t₅, of the current collector can be about 3, 5, 10, 15, 20, 25, 50, 100, 150, 200, 300, 400, or 500 μm. In embodiments, the thickness, t₅, of the current collector may be within a range formed by selecting any two numbers listed in the immediately previous sentence, e.g., between about 5 μm and about 500 μm.

### Manufacturing Method for the Anode Electrode

The anode electrode may be obtained by various methods, such as, for example, atomic deposition, extrusion, rolling, a slurry method, or a combination thereof. For example, the anode active material can be mixed and agitated with a solvent, and optionally a binder, and a dispersing agent to form slurry. Then, the slurry can be applied (e.g., coated) onto the current collector, followed by pressing and drying, to obtain the anode electrode. In addition to the methods mentioned, the anode electrode may be manufactured using various other techniques, including dry electrode processes. These alternative methods may offer advantages in terms of environmental impact, cost-effectiveness, and scalability.

Dry powder coating may be employed as an alternative to the slurry method. In this process, the anode active material, conductive additives, and binder are mixed in a dry state and then directly applied to the current collector using electrostatic deposition or mechanical compression. This method eliminates the need for solvents, potentially reducing environmental impact and processing time.

Additive manufacturing techniques, such as 3D printing, may be used to fabricate the anode electrode. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

Electrospinning is another potential method for manufacturing the anode electrode. In this process, a solution containing the anode active material, conductive additives, and a polymer binder is extruded through a nozzle under an electric field, resulting in the formation of nanofibers. These fibers can be collected directly on the current collector to form a highly porous electrode structure with increased surface area.

Tape casting may be employed to prepare the anode electrode. This technique involves spreading a slurry of electrode materials onto a moving carrier film using a doctor blade, followed by drying and calendering. The resulting electrode tape can then be laminated onto the current collector.

Spray coating techniques may be used to fabricate the anode electrode. A fine mist of the electrode slurry is sprayed onto the current collector using compressed air or ultrasonic atomization. This approach may allow for the creation of thin, uniform electrode layers and can be particularly useful for large-scale production.

Freeze-casting is another potential method for manufacturing the anode electrode. This process involves freezing a slurry of electrode materials, followed by sublimation of the ice to create a porous structure. The resulting porous electrode can then be sintered and attached to the current collector.

In some cases, a sol-gel process may be used to prepare the anode electrode. This method involves the formation of a colloidal suspension (sol) that is then converted into a gel-like network containing the anode active material and other components. The gel can be applied to the current collector and subsequently heat-treated to form the final electrode structure.

For certain applications, physical vapor deposition (PVD) or chemical vapor deposition (CVD) techniques may be employed to create thin film anodes directly on the current collector. These methods can produce highly uniform and dense electrode layers, which may be particularly beneficial for certain types of solid-state batteries.

Lastly, mechanical alloying and high-energy ball milling may be used to prepare composite anode materials, which can then be pressed into electrodes or applied to the current collector using one of the aforementioned methods. This technique can be particularly useful for creating nanostructured or amorphous anode materials with enhanced electrochemical properties.

### Ball Milling Generally

Ball milling is a valuable technique for mixing and preparing materials for solid-state batteries. Ball milling is a mechanical technique widely used to grind powders into fine particles and mix materials in various applications, including the preparation of solid-state battery components. In the context of solid-state batteries, ball milling is often employed to mix and blend the electrode materials, solid electrolytes, and other components. Exemplary ball milling devices may include planetary ball mills, attritor mills, and vibratory ball mills. These devices typically consist of a rotating or vibrating chamber containing grinding balls made of materials such as steel, ceramic, or zirconia.

### Homogeneous Mixing

Ball milling is effective in achieving a homogeneous mixture of different powders. This is crucial for ensuring uniform distribution of components in the electrode materials and solid electrolytes, which, in turn, impacts the overall performance of the battery.

### Reducing Particle Size

Ball milling can reduce the particle size of the materials involved, leading to increased surface area and improved reactivity. Smaller particle sizes can enhance the kinetics of electrochemical reactions, contributing to better battery performance.

### Enhanced Electrode-Electrolyte Interface

Ball milling can facilitate the formation of a well-defined interface between the electrode and solid electrolyte. This is important for promoting efficient ion transport and minimizing interfacial resistance within the solid-state battery.

### Promoting Solid-State Reactions

Ball milling can induce solid-state reactions between different components, promoting the formation of desired phases and structures in the materials. This is particularly relevant for the synthesis of composite electrode materials or preparation of the composite electrolyte materials provided herein.

### Optimizing Conductivity

Ball milling can be used to optimize the conductivity of electrode materials by ensuring a good distribution of conductive additives, such as carbon or metal nanoparticles, within the composite; or the additive materials, within the solid electrolyte, as provided herein.

### Controlling Morphology

The milling process can also influence the morphology of the materials, including particle shape and size distribution. Controlling these aspects is important for achieving the desired electrochemical properties and overall performance of the solid-state battery.

### Energy Considerations

Ball milling is an energy-intensive process, and the duration and speed of milling need to be carefully controlled to avoid excessive heating, which could lead to undesired reactions or damage to the materials.

### Application Methods for Slurry for Anode Electrode

The application of the slurry for the anode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating. Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for the Slurry for the Anode Electrode

The solvent for forming the anode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene. In some embodiments, the anode electrode may be prepared using a solvent-free method, such as dry powder processing or melt extrusion, which eliminates the need for liquid solvents and may offer environmental and cost benefits.

### Dispersing Agent for Slurry for the Anode Electrode

The dispersing agent forming the anode electrode may include an aqueous dispersing agent and/or an organic dispersing agent, such as, for example, N-methyl-2-pyrrolidone. The dispersing agent forming the anode electrode may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers. In some embodiments, the anode electrode 104 may be prepared using methods that do not require a dispersing agent, such as dry powder processing or certain additive manufacturing techniques.

### Drying Technique for the Anode Electrode

The slurry for the anode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104. In addition to the drying techniques mentioned, several other methods may be employed to dry the anode electrode slurry. These additional techniques can offer various advantages depending on the specific materials, production requirements, and desired electrode properties.

Infrared (IR) drying may be used to rapidly heat the electrode surface, promoting efficient solvent evaporation. This method can be particularly effective for thin electrode coatings and may allow for precise control of the drying process. Microwave drying is another option that can provide volumetric heating of the electrode material, potentially leading to more uniform drying throughout the electrode thickness. In some cases, a combination of convection and microwave drying may be employed to optimize both drying speed and uniformity.

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

In some cases, a two-step drying process may be employed. For example, initial drying may be performed at a lower temperature to remove bulk solvent, followed by a higher temperature step to remove residual solvent and potentially initiate any desired chemical reactions within the electrode material.

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer is suitable for lithium ion diffusion between the cathode electrode and the anode electrode. The solid electrolyte layer provides an electrically conductive pathway for the movement of charge carriers between the cathode electrode and the anode electrode. The solid electrolyte layer is in electrical communication with the cathode electrode and the anode electrode. In embodiments, the solid electrolyte layer is formed over and in direct contact with the cathode electrode or the anode electrode. In embodiments, the solid electrolyte layer is in direct contact with the cathode electrode and the anode electrode. In other embodiments, another functional layer may be interposed between the solid electrolyte layer and the cathode electrode and/or the anode electrode.

The solid electrolyte layer may have a gradient structure, with composition or properties that vary across its thickness to optimize ion transport and interfacial compatibility. For example, the layer could have higher ionic conductivity near the electrodes and higher mechanical strength in the middle.

In some embodiments, the solid electrolyte layer may be formed as a composite, incorporating both ceramic and polymer components to balance mechanical properties and ion conductivity. The ceramic component could provide structural stability while the polymer enhances flexibility and electrode contact.

The solid electrolyte layer may include engineered porosity or channels to facilitate ion transport while maintaining mechanical integrity. These could be created through techniques like freeze-casting or templating.

In certain configurations, the solid electrolyte layer may be applied as multiple thin sublayers with slightly different compositions or properties, allowing for fine-tuning of the overall layer characteristics.

The interface between the solid electrolyte and electrodes may be modified through surface treatments or the addition of buffer layers to improve adhesion and reduce interfacial resistance. This could involve plasma treatment, chemical modification, or deposition of nanoscale interface layers.

In some embodiments, the solid electrolyte layer may incorporate self-healing properties, such as the inclusion of microcapsules containing electrolyte material that can repair small cracks or defects that form during cycling.

The solid electrolyte layer may be designed with anisotropic properties, having different ionic conductivities in different directions to optimize ion transport between electrodes while minimizing unwanted side reactions.

In certain configurations, the solid electrolyte layer may include embedded current collectors or conductive networks to enhance charge transport and distribution across the battery structure.

The solid electrolyte layer may be formulated to have temperature-dependent properties, optimizing performance across a wide range of operating conditions. This could involve phase-change materials or components with different thermal expansion coefficients.

In some embodiments, the solid electrolyte layer may be designed to be pressure-sensitive, with ionic conductivity that improves under moderate compression to enhance performance during battery operation.

### Material for Solid Electrolyte Layer

The solid electrolyte layer may be capable of transport of lithium ions. The material of the solid electrolyte layer is not particularly limited as long as it allows adhesion with adjacent layers, has a suitable electrical conductivity, and does not cause significant chemical changes in the corresponding solid-state battery in the voltage range of the solid-state battery. For example, besides the composite solid electrolyte materials including the additive material and the sulfide containing solid electrolyte material provided herein, the solid electrolyte layer may include various inorganic solid electrolytes, polymer solid electrolytes, polymer gel electrolytes, although not limited thereto. Additionally, or alternatively, the solid electrolyte layer may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li₃OCl and Li₃OBr, lithium nitride (Li₃N), and lithium borohydride (LiBH₄) have been investigated as potential solid electrolyte materials for lithium-ion batteries.

### Sulfide Based Solid Electrolyte

As provided herein, the sulfide-based solid electrolyte includes sulfur (S) and has ionic conductivity of metal belonging to Group I or Group II of the periodic table, and may include Li—P—S-based glass or Li—P—S-based glass ceramics. For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, XLi₂S-(100-x)P₂S₅(x=70-80), Li₂S—SiS₂—Li₃N, Li₂S—P₂S₅—LiI, Li₂S—SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅ (LATP), Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₁₀GeP₂S₁₂ (LGPS), Li₇P₃S₁₁, Li₆PS₅Cl, Li₆PS₅Br, Li₆PS₅I, Li_{9.54}Si_{1.74}P_{1.44}S_{11.7}Cl_{0.3}, Li₁₁Si₂PS₁₂, the like, or combinations thereof. In some cases, doped variants of these materials, such as Al-doped Li₁₀GeP₂S₁₂ or Sb-doped Li₆PS₅Cl, may also be employed to further enhance ionic conductivity or stability.

### Oxide Based Solid Electrolyte

The oxide-based solid electrolyte material contains oxygen (O) and has ionic conductivity of metal belonging to Group I or II of the periodic table. The oxide-based solid electrolyte material may include at least one selected from the group consisting of LLTO-based compounds, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y}(PO₄)_{3-y}(0≤x≤1, 0≤y≤1), LiAlₓZr₂₋ₓ (PO₄)₃ (0≤x≤1, 0≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li₇La₃Zr₂O₁₂ and Ta-doped Li₇La₃Zr₂O₁₂). Lithium-rich anti-perovskites like Li₃OCl and Li₃OBr have also been investigated as potential oxide-based solid electrolytes. In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyagitation lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof. The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof. Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of at least one selected from the group consisting of F⁻, Cl⁻, Br⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF−, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH, CF₃(CF₂)₇SO₃⁻, CF₃CO₂—, CH₃CO₂⁻, SCN⁻, (CF₃CF₂SO₂)₂N⁻, and the like. For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂)·2NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 50, 60, 70, 80, 100, 200, 300, or 400 parts of electrolyte salt, if present, based on the total weight of the solid electrolyte layer. In embodiments, electrolyte salt in the solid electrolyte layer may be within a range formed by selecting any two numbers listed in the immediately previous sentence, e.g., between about 0 parts and about 400 parts, or about 60 parts and 400 parts based on the total weight of the solid electrolyte layer.

### Ion Conductivity of the Solid Electrolyte Layer

The solid electrolyte layer can include a suitable reduction stability and/or ion conductivity. Since the solid electrolyte layer mainly functions to transport lithium ions between electrodes, the solid electrolyte layer can include a desirable ion conductivity of at, about, or greater than, 10⁻⁷ S/cm, 10⁻⁶ S/cm, 10⁻⁵ S/cm, or 10⁻⁴ S/cm.

### Thickness of the Solid Electrolyte Layer

A thickness, t₆, of the solid electrolyte layer can be about 3, 5, 10, 15, 20, 25, 30, 50, 70, 100, 150, 200, 300, 400, 500, or 1,000 μm. In embodiments, the thickness, t₆, of the solid electrolyte layer may be within a range formed by selecting any two numbers listed in the immediately previous sentence, e.g., between about 5 μm and about 1,000 μm, about 30 μm and about 100 μm, or about 30 μm and about 50 μm.

### Unfinished Product

The cell can be provided as an unfinished product. In embodiments, the cell is stored, transported, and/or delivered to a reseller, customer, or the like that finishes manufacture of a battery assembly or product comprising the cell. In other embodiments, the cell is a finished battery assembly or product.

### Seal the Battery

An enclosure of the solid-state battery can be sealed to finish making the solid-state battery such that it will work as a battery. The sealing process may involve various techniques to ensure the internal components are protected from external environmental factors and to maintain the integrity of the battery structure. For example, the enclosure may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation. Once properly sealed, the solid-state battery is ready for final quality control checks, which may include electrical testing, leak detection, and visual inspections. After passing these checks, the solid-state battery could be packaged and sold as a finished product, ready for integration into various electronic devices, electric vehicles, energy storage systems, and so forth.

### Battery Configured

The solid-state battery is provided in various configurations to suit different applications and device requirements. In some aspects, the battery may be manufactured in a cylindrical form, which can be advantageous for certain types of portable electronics or automotive applications. Alternatively, the solid-state battery may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery. The choice of configuration may depend on factors such as the intended use, space constraints, thermal management requirements, and manufacturing considerations. In some embodiments, hybrid or custom configurations combining elements of different forms may be utilized to meet specific design needs. The versatility in battery form factors can enable the integration of solid-state batteries into a wide range of products, from small wearable devices to large-scale energy storage systems.

### Voltage

The solid-state battery is configured to output a voltage of at or about 1, 2, 3, 4, 5, 6, 10, 12, 20, 24, 30, 40, 48, 50, 60, 70, 80, 90, 96, 100, 200, 300, 400, or 500 V DC. In embodiments, the output voltage of the solid-state battery may be within a range formed by selecting any two numbers listed in the immediately previous sentence, e.g., between about 1 V DC and about 500 V DC.

### Capacity

The solid-state battery is configured to have a specific capacity of at, about, or greater than 100, 110, 120, 130, 140, 150, 160, 170, 180, 190, 200, or 300 mAh/g. In embodiments, the output voltage of the solid-state battery 100 may have a capacity formed by selecting any two numbers listed in the immediately previous sentence, e.g., between about 100 mAh/g and about 300 mAh/g.

### Volume Expansion Calculation

The solid-state battery can include a desirable volume expansion rate. The volume expansion rate may be calculated from an increase amount of thickness after a first cycle of charging and discharging compared to an initial thickness. The volume expansion rate means a ratio of an amount of change in a thickness increased after a first cycle of charging and discharging to an initial thickness of a particular element. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope

$$Volume expansion rate = [ ( B - A ) / A ] \times 100 C - Rate \qquad Equation 1$$

C-rate as used herein refers to the rate at which the battery is discharged relative to its maximum capacity. For example, a 1C rate means the discharge current will discharge the entire battery within one hour. That is, for a battery with a capacity of 20 Amp-hrs, a discharge current at a 1C would be 20 Amps.

Other exemplary ways to measure and calculate the volume expansion rate for a solid-state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### EXAMPLES

The following examples are not intended to be limiting. The above disclosure provides many different aspects for implementing the features of the disclosure, and the following examples describe certain aspects. It will be appreciated that other modifications and methods known to one of ordinary skill in the art may also be applied to the following experimental procedures, without departing from the scope of the disclosure.

### Example 1

Example 1 was formed as follows. SiOx was used as negative electrode active material. Li₆PS₅Cl (LPSCl, NEI Corporation, USA) was used for solid-state electrolyte (SSE) separator layer and cathode composite preparation. For cathode composite purpose, the LPSCl particle size was reduced using E_{MAX} ball mill (Retsch, Germany). The ball milling was conducted for 2 hours at 300 rpm, using anhydrous xylene as a medium. Lithium cobalt oxide (LCO, MSE Supplies, USA), coated with a niobium-based layer, was used as received. Cathode composite was prepared by hand-mixing using a weight ratio of LCO:LPSCl=70:30. Li metal chip was rolled and punched into 10 mm diameter discs before use to pre-lithiate the SiOx to compensate the first cycle loss. Micro-Si (Sigma) and silicon monoxide (Alfa Aesar) were casted on Cu foil with 0.1% polyvinylidene fluoride (PVDF). The negative electrode film was punched into 10 mm diameter discs.

The negative electrode was pre-lithiated to 0.98 mAh/cm⁻² according to the following controlled pre-lithiation protocol. Two titanium rods were used as current collectors at each end of the working and the counter electrode. The solid-state separator layer was fabricated by first putting 75 mg of LPSCl in a 10 mm inner diameter polyether ether ketone holder, which was then compressed between two titanium rods at 370 MPa. The negative electrode (Si or SiOₓ) film was inserted on top of LPSCl pellet and pressed to 370 MPa for 3 min. Afterward, 15 mg of LPSCl was spread on the opposite of the negative electrode, and compressed at 120 MPa for 10 s. The Li metal was placed on top of the opposite side of the negative electrode, and the whole cell was held at 25 MPa for 30 min to facilitate the Li wetting. The cell was set to 15 MPa before the pre-lithiation start and the negative electrode was pre-lithiated with the capacity cutoff to compensate the first cycle loss of the pristine negative electrode.

After the controlled pre-lithiation, Li metal was removed with the titanium rod. At this point, 15 mg of loosely compressed LPSCl was removed with Li metal cleanly. The LCO composite was added on the Li removed side as a cathode layer. The cell with the LCO composite was compressed at 370 MPa for 3 min and was set to 75 MPa before cycling started at room temperature.

### Comparative Example 1

Comparative Example 1 was formed in a manner similar to Example 1 except that Si was used as negative electrode active material and the negative electrode was pre-lithiated to 0.98 mAh/cm⁻² according to conventional (i.e., non-controlled) lithiation.

### Comparative Example 2

Comparative Example 2 was formed in a manner similar to Example 1 except that the negative electrode was pre-lithiated to 0.98 mAh/cm⁻² according to conventional (i.e., non-controlled) lithiation.

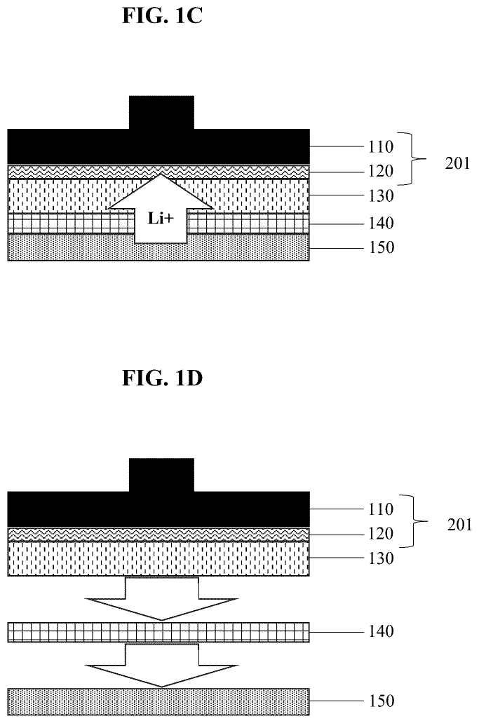

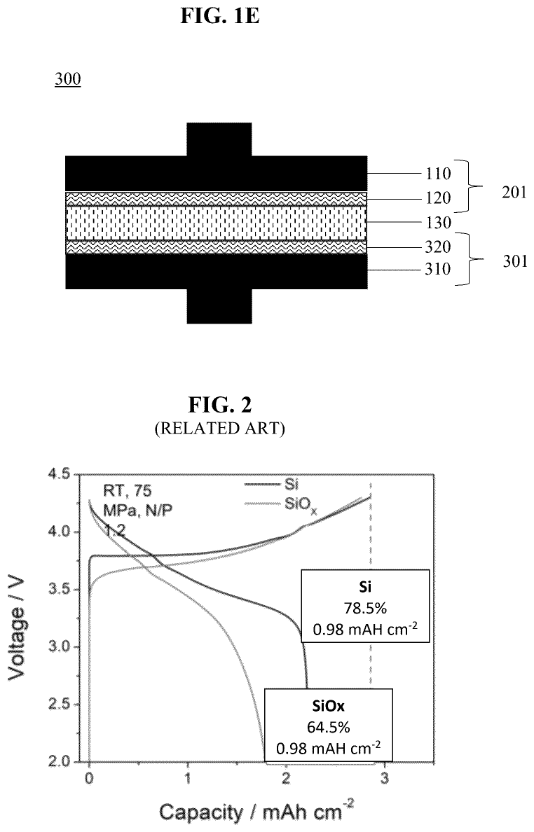

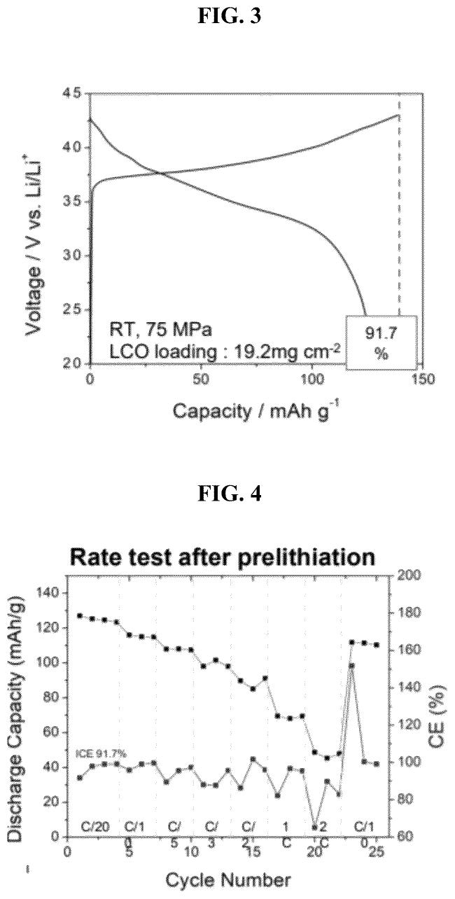

As seen in FIG. 2, Comparative Example 1 and Comparative Example 2 exhibited an initial columbic efficiency of 78.5% and 64.5%, respectively. As seen in FIG. 3, Example 1 exhibited an initial columbic efficiency of 91.7%. Moreover, Example 1 maintained stable discharge capacity and columbic efficiency at several discharge rates over several cycles, as seen in FIG. 4. These results show that negative electrodes pre-lithiated according to the disclosed controlled pre-lithiation methods exhibited increased initial columbic efficiency and lifetime characteristics.

It will be understood by those of ordinary skill in the art that aspects of the present disclosure may be performed within a wide equivalent range of parameters without affecting the scope of the disclosure described herein. All publications, patent applications and patents disclosed herein are incorporated by reference in their entirety.

1. A method of pre-lithiating a negative electrode for an all-solid-state battery, the method comprising, in sequential order:
(i) contacting a surface of the negative electrode with a solid electrolyte and applying a first pressure to form a first solid electrolyte layer on the negative electrode;
(ii) applying additional solid electrolyte on a surface of the first solid electrolyte layer opposite a surface facing the negative electrode and applying a second pressure to form a second solid electrolyte layer on the surface of the first solid electrolyte layer;
(iii) bringing a lithium metal into contact with a surface of the second solid electrolyte layer opposite a surface facing the first solid electrolyte layer;
(iv) charging the negative electrode during at least one initial cycle for a duration of time to form a pre-lithiated negative electrode; and
(v) removing the lithium metal from the surface of the second solid electrolyte layer.

2. The method of pre-lithiating the negative electrode according to claim 1, further comprising removing second solid electrolyte layer from the surface of the first solid electrolyte layer.

3. The method of pre-lithiating the negative electrode according to claim 1, wherein the at least one initial cycle is a first cycle.

4. The method of pre-lithiating the negative electrode according to claim 1, wherein the second pressure is less than the first pressure.

5. The method of pre-lithiating the negative electrode according to claim 1, wherein the first pressure is in a range of 200 MPa to 1,000 MPa.

6. (canceled)

7. The method of pre-lithiating the negative electrode according to claim 1, wherein the second pressure is in a range of 10 MPa to 200 MPa.

8. (canceled)

9. The method of pre-lithiating the negative electrode according to claim 1, wherein the first pressure is applied for a first duration of time and the second pressure is applied for a second duration of time, and the second duration of time is less than the first duration of time.

10. The method of pre-lithiating the negative electrode according to claim 1, wherein the first pressure is applied for a first duration of time in a range of 30 seconds to 2 hours.

11. The method of pre-lithiating the negative electrode according to claim 1, wherein the second pressure is applied for a second duration of time in a range of 1 second to 10 minutes.

12. The method of pre-lithiating the negative electrode according to claim 1, wherein the negative electrode comprises a negative electrode active material layer comprising at least one of a silicon-containing material and a tin-containing material.

13. The method of pre-lithiating the negative electrode according to claim 1, wherein the negative electrode comprises SiOx, wherein 0≤x<2.

14. The method of pre-lithiating the negative electrode according to claim 1, wherein a thickness of the first solid electrolyte layer is in a range of 100 μm to 1 mm.

15. The method of pre-lithiating the negative electrode according to claim 1, wherein a thickness of the second solid electrolyte layer is in a range of 0.5 μm to 10 μm.

16. A negative electrode precursor for an all-solid-state battery, the negative electrode precursor comprising:
a negative electrode;
a first solid electrolyte layer formed on a surface of the negative electrode at a first pressure, and
a second solid electrolyte layer formed on a surface of the first solid electrolyte layer opposite a surface facing the negative electrode at a second pressure;
wherein the second solid electrolyte layer is configured to be removed from the surface of the first solid electrolyte layer after an initial charging of the negative electrode during at least one initial cycle for a duration of time, and
wherein the second pressure is less than the first pressure.

17. The negative electrode precursor according to claim 16, further comprising a lithium metal on a surface of the second solid electrolyte layer opposite a surface facing the first solid electrolyte layer.

18. The negative electrode precursor according to claim 17, wherein the lithium metal is configured to be removed with the second solid electrolyte layer after the initial charging of the negative electrode.

19. A lithium all-solid-state battery comprising:
a positive electrode; and
the pre-lithiated negative electrode prepared according to the method of claim 1 on the positive electrode.

20. An electric vehicle comprising the lithium all-solid-state battery according to claim 19.

21. The method of pre-lithiating the negative electrode according to claim 1, wherein in step (ii) the additional solid electrolyte is applied directly on the surface of the first solid electrolyte layer.

22. The negative electrode precursor according to claim 16, wherein the first pressure is in a range of 200 MPa to 1,000 MPa, and
the second pressure is in a range of 10 MPa to 200 MPa.
